(19) United States
(12) Patent Application Publication
(10) Pub. No.: US 2014/0043324 A1
(43) Pub. Date: Feb. 13, 2014

(54) 3D DISPLAY SYSTEM AND 3D DISPLAYING METHOD

(71) Applicant: NVIDIA CORPORATION, Santa Clara, CA (US)

(72) Inventor: Shuang Xu, Shenzhen (CN)

(73) Assignee: NVIDIA CORPORATION, Santa Clara, CA (US)

(21) Appl. No.: 13/667,905

(22) Filed: Nov. 2, 2012

(30) Foreign Application Priority Data
Aug. 13, 2012 (CN) 201210287680.0

(51) Int. Cl. G06T 15/00

(52) U.S. Cl. CPC G06T 15/00
USPC 345/419

(57) ABSTRACT

A 3D display system and a 3D displaying method are provided in the present invention. The 3D display system comprising: a display device; a detecting device, for detecting a viewing position of a viewer; and a control device, for controlling a video frame to be converted onto a virtual plane perpendicular to visual line of the viewing position according to the viewing position, and mapping converted video frame onto the display device to display a 3D image on the display device. The 3D display system provided by the present invention adjusts the virtual plane, onto which the video frame is converted, by detecting the viewing position of the viewer, such that the 3D image displayed on the display device can be adjusted according to the viewing position of the viewer. It causes that the viewer can view the 3D image having no deflection, without being limited by the viewing position.

### CROSS-REFERENCE TO RELATED APPLICATIONS

This application claims priority to Chinese Patent Application No. 201210287680.0), filed on Aug. 13, 2012, which is hereby incorporated by reference in its entirety.

### FIELD OF INVENTION

The present invention relates generally to 3D technology, in particular, to a 3D display system and a 3D displaying method.

### BACKGROUND

3D technology is more and more widely used in modern life. 3D technology separates the images seen by left and right eyes of a human by means of the principle, that the angles in which two eyes view objects are slightly different so that it is able to distinguish the distance of the objects and form stereo visual effect, so as to make the user experience stereo perception. Recently, 3D display devices (such as 3D TVs, etc.) adopting the 3D technology have come into families.

However, when a viewer views a 3D image 120 (such as a tetrahedron) on a display device 110, as shown in FIG. 1, the viewed 3D image is consistent with the 3D image 120 displayed on the display device 110, if the viewer is in right front of the display device 110 (i.e. Position A). If the viewer is in right front of the display device 110 and to the left (i.e. Position B) or in right front of the display device 110 and to the right (i.e. Position C), the viewed 3D image would present deflection, as shown by the tetrahedrons below the viewers at Positions A and C in FIG. 1 correspondingly. That is to say, if the viewer wants to view a 3D image without any deflection, he/she has to be in right front of the display device and eliminate all limiting factors. Obviously, in some cases, it is inconvenient, even impossible.

Therefore, there is a need of providing a 3D display system and a 3D displaying method to solve the above problems in the prior art.

### SUMMARY OF THE INVENTION

In view of the drawback in the prior art, a 3D display system is provided in the present invention, comprising: a display device; a detecting device, for detecting a viewing position of a viewer; and a control device, for controlling a video frame to be converted onto a virtual plane perpendicular to a visual line of the viewing position according to the viewing position, and mapping the converted video frame onto the display device to display a 3D image on the display device.

Preferably, the 3D display system further comprises 3D glasses, and the detecting device comprises a detecting signal transmitter disposed on the 3D glasses and a detecting signal receiver disposed on the display device, the detecting signal receiver receiving a detecting signal transmitted by the detecting signal transmitter to determine the viewing position.

Preferably, the 3D glasses comprise a plurality pairs of 3D glasses worn by a plurality of viewers respectively, and each of the plurality pairs of 3D glasses has an identity code.

Preferably, the control device controls the video frame to be converted onto the corresponding virtual plane according to the viewing position of each viewer, and maps the converted video frames onto the display device in sequence to display the corresponding 3D image on the display device in sequence.

Preferably, the control device controls the corresponding 3D glasses according to each identity code, so as to operate when the display device displays the corresponding 3D image.

Preferably, the control device groups the plurality of viewers according to each viewing position and calculates an average viewing position for each group of the viewers.

Preferably, the control device controls the video frame to be converted onto an average virtual plane perpendicular to a visual line of the average viewing position according to the average viewing position of each group of the viewers, respectively, and maps the converted video frames onto the display device in sequence to display the corresponding 3D image on the display device in sequence.

Preferably, the control device controls the corresponding group of the 3D glasses according to each group of the identity codes, so as to simultaneously operate when the display device displays the corresponding 3D image.

Preferably, the control device divides the plurality of viewers into 2-3 groups according to each viewing position.

A 3D displaying method is provided in the present invention, comprising the following steps: detecting a viewing position of a viewer; controlling a video frame to be converted onto a virtual plane perpendicular to a visual line of the viewing position according to the viewing position; and mapping the converted video frame to display a 3D image.

Preferably, the detecting step comprises a step of providing 3D glasses for the viewer, to determine the viewing position by detecting the position of the 3D glasses.

Preferably, the providing step comprises providing a plurality pairs of 3D glasses for a plurality of viewers, and each of the plurality pairs of 3D glasses has an identity code.

Preferably, the controlling step comprises controlling the video frame to be converted onto the corresponding virtual plane according to the viewing position of each viewer, and the mapping step comprises mapping the converted video frames in sequence to display the corresponding 3D image in sequence.

Preferably, the 3D displaying method further comprises controlling the corresponding 3D glasses according to each identity code, so as to operate when the corresponding 3D image is displayed.

Preferably, the 3D displaying method further comprises grouping the plurality of viewers according to each viewing position, and calculating an average viewing position for each group of the viewers.

Preferably, the controlling step comprises controlling the video frame to be converted onto an average virtual plane perpendicular to a visual line of the average viewing position according to the average viewing position of each group of the viewers, respectively, and the mapping step comprises mapping the converted video frames in sequence to display the corresponding 3D image in sequence.

Preferably, the 3D displaying method further comprises controlling the corresponding group of the 3D glasses according to each group of the identity codes, so as to simultaneously operate when the corresponding 3D image is displayed.

Preferably, the grouping the plurality of viewers comprises dividing the plurality of viewers into 2-3 groups according to each viewing position.

The 3D display system provided by the present invention adjusts the virtual plane, onto which the video frame is converted, by detecting the viewing position of the viewer, such that the 3D image displayed on the display device can be adjusted according to the viewing position of the viewer. It causes that the viewer can view the 3D image having no deflection, without being limited by the viewing position.

A serial of simplified conceptions are incorporated into the summary of the invention, which will be further described in more detail in the detailed description. The summary of the invention neither implies that it is intended to limit the essential features and necessary technical features of the technical solution to be protected, nor implies that it is intended to define the protection scope of the technical solution to be protected.

Advantages and features of the present invention will be described in detail below in connection with the accompanying drawings.

### BRIEF DESCRIPTION OF THE DRAWINGS

The following drawings of the present invention as a part of the present invention herein are used for understanding of the present invention, the embodiments and the descriptions thereof are illustrated in the drawings for explaining the principle of the present invention, in the drawings,

FIG. 1 is a schematic view showing that deflection occurs when the viewers view the image displayed on the display device in the prior art at different positions;

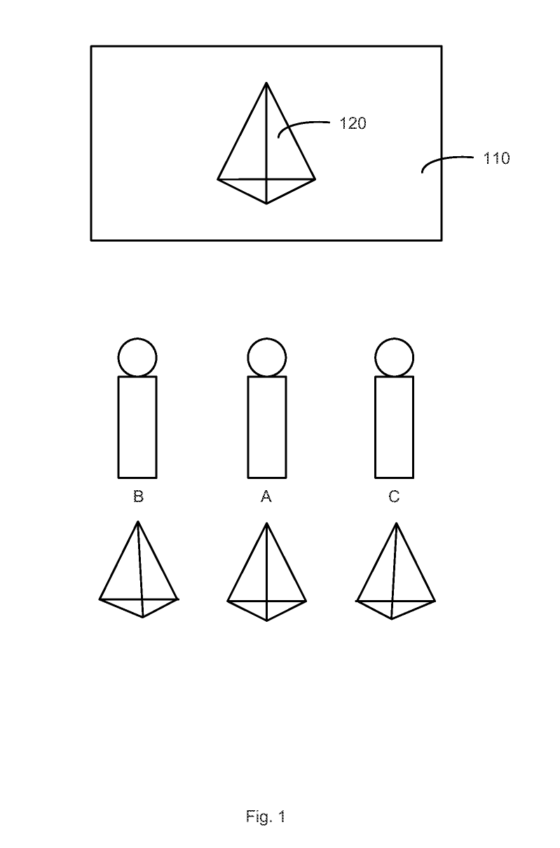

FIG. 2 is a schematic view showing that a viewer views the 3D display system in accordance with one embodiment of the present invention;

FIG. 3A is a schematic view showing that two viewers view the 3D display system in accordance with another embodiment of the present invention;

FIG. 3B is a timing diagram showing that the display device in FIG. 3A displays 3D image;

FIG. 4 is a timing diagram showing that the display device in accordance with one embodiment of the present invention displays 3D images for three viewers;

FIG. 5 is a schematic view showing that a plurality of viewers are grouped in accordance with one embodiment of the present invention; and

FIG. 6 is a flow chart of a 3D displaying method in accordance with one embodiment of the present invention.

### DETAILED DESCRIPTION

Now, the preferable embodiments of the present invention will be described in more details, the examples of which are illustrated in the figures. It is appreciated to those skilled in the art that the description below is only schematic, rather than intending to limit the present invention in any way.

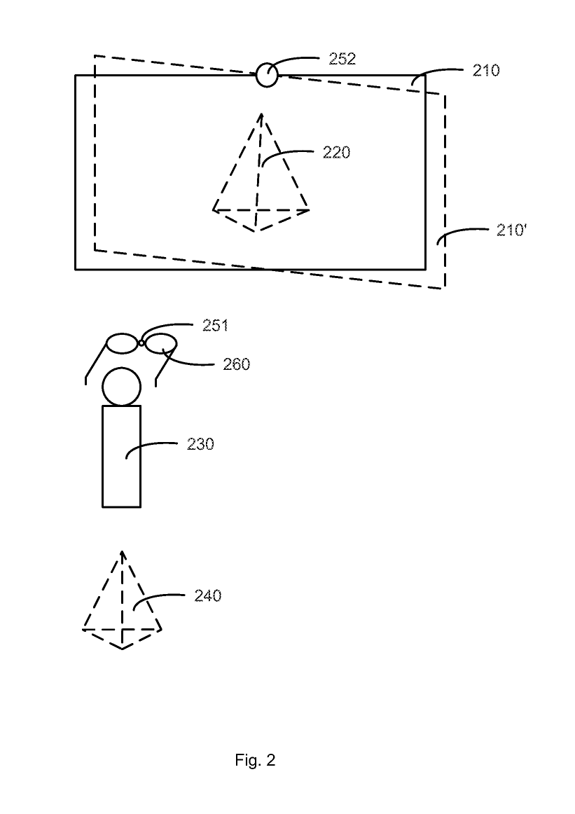

The present invention provides a 3D display system. A viewer can see the image displayed on the display device having no deflection anywhere by means of the 3D display system, without being limited by the viewing position. FIG. 2 shows a 3D display system in accordance with one embodiment of the present invention. The 3D display system will be described in detail by combining with FIG. 2 below. As shown in FIG. 2, the 3D display system basically comprises a display device 210, a detecting device and a control device.

The display device 210 may be any type of display device which can display 3D images, such as a liquid crystal display (LCD) device and an opaque projector, etc.

The detecting device is used for detecting a viewing position of a viewer. Specifically, the detecting device is used for detecting a viewing position of a viewer with respect to the display device. As shown in FIG. 2, a viewer 230 is in right front of the display device 210 and to the left. Of course, it is not intended to limit the viewing position of the viewer 230 by the present invention, and the shown position is only schematic. The detecting device may be any type of detecting device which can detect the position of the viewer 230. As an example, the detecting device may include a detecting signal transmitter 251 and a detecting signal receiver 252. As an example, the detecting signal transmitter 251 may transmit various detecting signals, such as infrared signals, microwave signals, sound signals and so on. The detecting signal receiver 252 receives the detecting signal transmitted by the detecting signal transmitter 251, and determines the viewing position of the viewer 230 according to the detecting signal. Preferably, when the 3D display system includes 3D glasses 260, the detecting signal transmitter 251 may be disposed on the 3D glasses 260. Of course, the detecting signal transmitter 251 may also be disposed at other positions besides the position on the 3D glasses 260. For example, it can be disposed on a seat (which is more suitable for the place with the seat being immovable, such as a cinema), or held by the viewer. However, it can be seen that the detecting signal transmitter 251 is preferably disposed on the 3D glasses 260 in non-naked eye 3D technology, such that the position of the detecting signal transmitter 251 can be consistent with the position of the viewer to indicate the position of the viewer conveniently and accurately. As an example, the detecting signal receiver 252 may be disposed on the display device 210.

The control device (not shown) may control a video frame to be converted onto a virtual plane 210′ perpendicular to a visual line of the viewing position according to the viewing position detected by the above detecting device. As an example, when the viewer 230 views the display device 210 in right front of the display device 210 and to the left, as shown in FIG. 2, the visual line of the viewer 230 viewing the display device 210 is not perpendicular to the display plane of the display device 210, but perpendicular to the virtual plane 210′ which is rotated by an angle in clockwise direction with respect to the display plane. The control device controls that the video frame 220 is converted onto the virtual plane 210′ firstly and then the converted video frame 220 is mapped onto the display device 210. In this way, the viewer 230 can see the 3D image 240 having no deflection. It can be understood that, each video frame 220 mentioned above should include a frame of left eye image and a frame of right eye image which are displayed alternately, wherein the binocular stadia may be set as the international average value, i.e., 6.35 cm (which can be fine tuned on demand). Then, the left eye image and the right eye image are alternately mapped onto the display device 210 under the control of the control device, which results in that the 3D image having depth of field and stereo effect displays on the display device 210. The steps mentioned above, such as converting and mapping, have been known by those skilled in the art, and thus, they will be not described in detail.

Summing up, the 3D display system provided by the present invention adjusts the virtual plane, onto which the video frame is converted, by detecting the viewing position of the viewer, such that the 3D image displayed on the display device can be adjusted according to the viewing position of the viewer. It causes that the viewer can view the 3D image having no deflection, without being limited by the viewing position.

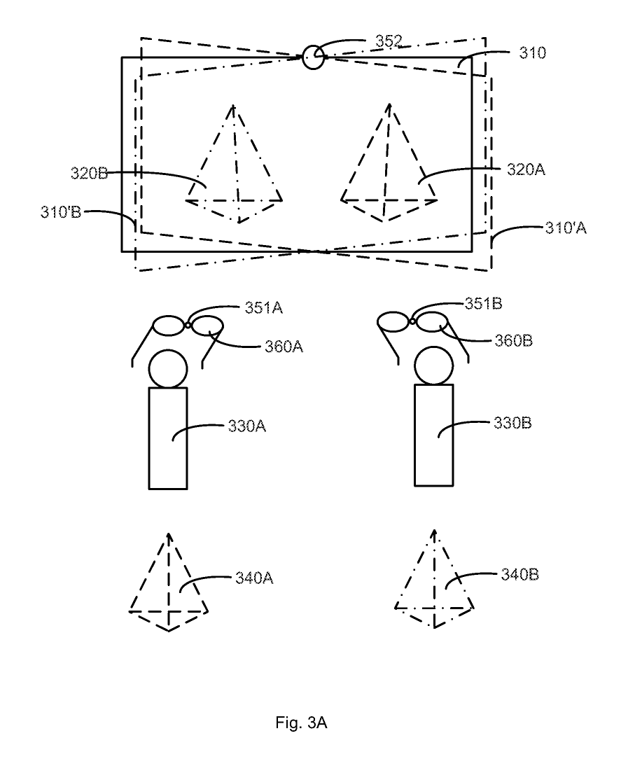

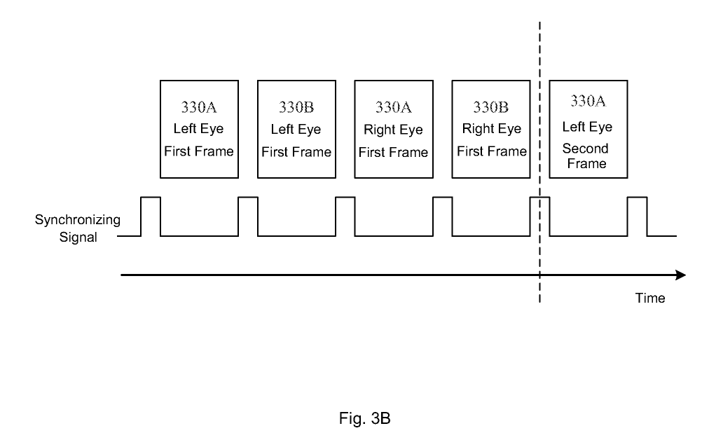

Further, when there are a plurality of viewers, such as two, three or more, the 3D glasses shown in FIG. 2 may comprise two pairs of 3D glasses 360A and 360B (as shown in FIG. 3A), or comprise three pairs of 3D glasses, or comprise more pairs of 3D glasses, such that each of the plurality of viewers wears one pair of 3D glasses. In the event that there are many pairs of 3D glasses in the 3D display system, each pair of 3D glasses has an identity code. The control device may identify each pair of 3D glasses by the identity code to control the operation of each pair of 3D glasses. This will be described in detail below. When the detecting device includes the detecting signal transmitter 251 and the detecting signal receiver 252 (referring to FIG. 2) and the detecting signal transmitter 251 is disposed on the 3D glasses, each pair of 3D glasses should be provided with the detecting signal transmitter 251, but it may include one or more detecting signal receiver 252. In such cases, the identity code of each pair of 3D glasses may be sent to the detecting signal receiver though the corresponding detecting signal transmitter.

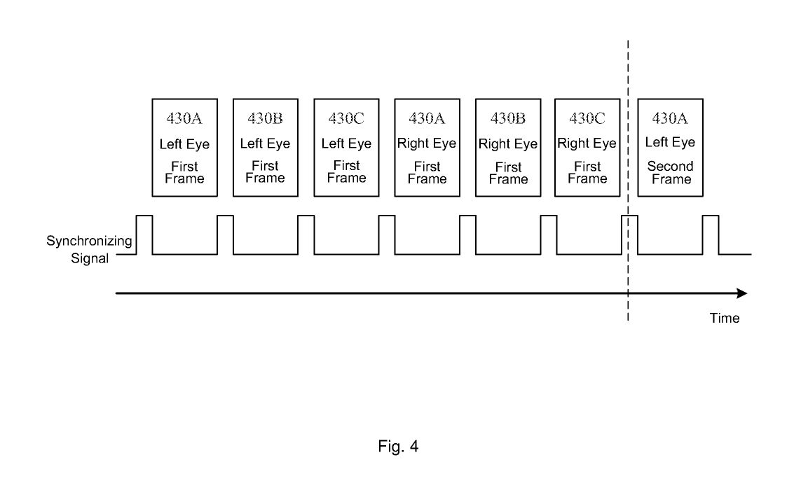

In accordance with one embodiment of the present invention, the control device controls the video frame to be converted onto the corresponding virtual plane according to the viewing position of each viewer, and the converted video frames are mapped onto the display device in sequence, such that the corresponding 3D images may be displayed onto the display device in sequence. The preferable embodiment will be described in detail below by combining with FIGS. 3A-3B and FIG. 4.

FIGS. 3A and 3B are the schematic view and the timing diagram of the 3D display system in accordance with one embodiment of the present invention, respectively. The 3D display system is basically the same as the 3D display system shown in FIG. 2, and the difference between them lies in that the 3D display system shown in FIG. 2 is suitable for one viewer, while the 3D display system shown in FIG. 3 is suitable for two viewers. In the 3D display system for two viewers, at least two pairs of glasses should be provided. The first viewer 330A in right front of the display device 310 and to the left wears the first 3D glasses 360A, and the second viewer 330B in right front of the display device 310 and to the right wears the second 3D glasses 360B. The first 3D glasses 360A has the first identity code, and the first detecting signal transmitter 351A is disposed thereon. When the first detecting signal transmitter 351A transmits the first detecting signal being capable of indicating the viewing position of the first viewer 330A, it also sends the first identity code of the first 3D glasses 360A to the detecting signal receiver 352. The second 3D glasses 360B has the second identity code, and the second detecting signal transmitter 351B is disposed thereon. When the second detecting signal transmitter 351B transmits the second detecting signal being capable of indicating the viewing position of the second viewer 330B, it also sends the second identity code of the second 3D glasses 360B to the detecting signal receiver 352.

The control device converts the video frame onto the first virtual plane 310′A (indicated by the dotted lines) according to the viewing position of the first viewer 330A to obtain the converted first video frame 320A, wherein the first virtual plane 310′A is perpendicular to the visual line of the first viewer 330A when viewing at his viewing position. Moreover, the control device converts the video frame onto the second virtual plane 310′B (indicated by the dash and dot lines) according to the viewing position of the second viewer 330B to obtain the converted second video frame 320B, wherein the second virtual plane 310′B is perpendicular to the visual line of the second viewer 330B when viewing at his viewing position. In addition, the control device also controls the first video frame 320A converted onto the first virtual plane 310′A and the second video frame 320B converted onto the second virtual plane 310′B to be mapped onto the display device 310 in sequence. In this way, the first viewer 330A and the second viewer 330B can see the 3D images 340A and 340B having no deflection, respectively.

As shown in FIG. 3B, the first video frame 320A and the second video frame 320B provided for the first viewer 330A and the second viewer 330B are mapped onto the display device 310 in sequence. In order to present the 3D effect, each video frame should include a frame of left eye image and a frame of right eye image displayed alternately. In the first cycle for displaying 3D image, firstly, the first frames of left eye image of the first video frame 320A and the second video frame 320B are mapped in turn, and then the first frames of right eye image of the first video frame 320A and the second video frame 320B are mapped in turn, such that the display of the first frame of 3D image is achieved for the first viewer 330A and the second viewer 330B, respectively. In the second cycle for displaying 3D image, firstly, the second frames of left eye image of the first video frame 320A and the second video frame 320B are mapped in turn, and then the second frames of right eye image of the first video frame 320A and the second video frame 320B are mapped in turn, such that the display of the second frames of 3D image is achieved for the first viewer 330A and the second viewer 330B, respectively. Repeat the above steps to display the third frames of 3D image, the fourth frames of 3D image, etc., until the display of all images are achieved. Of course, during the display of each video frame, the right eye image may be displayed before the left eye image.

On the basis of the display of the video frame according to the above regulation, in order to enable the two viewers to view the 3D image, it is necessary to control the first 3D glasses 360A of the first viewer 330A and the second 3D glasses 360B of the second viewer 330B. The control device controls the corresponding 3D glasses to operate when the display device 310 displays the corresponding 3D images according to each of the identity codes. The operation refers to that the left or right eye of the 3D glasses opens only when the corresponding left or right eye image is displaying, and closes at other time. Specifically, the left eye of the first 3D glasses 360A opens during displaying the left eye image of the first video frame 320A, and the right eye of the first 3D glasses 360A opens during displaying the right eye image of the first video frame 320A. The left eye of the second 3D glasses 360B opens during displaying the left eye image of the second video frame 320B, and the right eye of the second 3D glasses 360B opens during displaying the right eye image of the second video frame 320B.

As an example, the operation of the 3D glasses may be controlled by the synchronizing signal transmitted by the control device. Each pulse of the synchronizing signal may include a code bit and a status bit, wherein the code bit is used for searching for the 3D glasses with the matching identity code and the status bit is used for controlling the status of left or right eye of the 3D glasses. For example, the first 3 bits of each pulse may be the code bit, for identifying the identity code of the 3D glasses. The last bit is status bit. When the level of the last bit is for example +5V (or +3V, etc.), the left eye of the 3D glasses opens. When the level of the last bit is for example −5V (or −3V, etc.), the right eye of the 3D glasses opens.

Of course, the 3D display system provided by the present invention also adapts to three or more viewers, which is basically the same as the embodiment described by FIGS. 3A and 3B. The difference between them lies in that the 3D display system includes at least three pairs of 3D glasses. In addition, the difference also includes that three (or more) viewers need three (or more) viewing position. That is the video frame is converted onto three (or more) virtual planes, and mapped onto the display device in sequence. FIG. 4 is a timing diagram illustrating that the display device displays 3D images for three viewers 430A, 430B and 430C in sequence. In the first cycle for displaying 3D image, the first frames of left eye images are firstly displayed for the three viewers 430A, 430B and 430C in turn, and then the first frames of right eye images are displayed in turn, such that the display of the first frames of 3D images is achieved for the three viewers 430A, 430B and 430C, respectively. In the second cycle for displaying 3D image, the second frames of left eye images are firstly displayed for the three viewers 430A, 430B and 430C in turn, and then the second frames of right eye images are displayed in turn, such that the display of the second frames of 3D images is achieved for the three viewers 430A, 430B and 430C, respectively. Repeat the above steps to display the third frames of 3D image, the fourth frames of 3D image, etc., until the display of all images are achieved.

The images seen by eyes do not flash when the frame rate is no less than 120 frames per second (FPS). At present, the frame rate of the display device may reach 240 PFS. It will reach 360 PFS in the near future. If the 3D display system provided by the present invention displays 3D image for two persons, it is required that the frame rate of the display device at least reaches 240 PFS to ensure the display quality of the image. If it displays 3D image for three persons, it is required that the frame rate of the display device at least reaches 360 PFS, which is a great requirement for the display device.

In order to overcome the limitation, the present invention provides another 3D display system. The 3D display system is basically the same as the above 3D display systems, for example, it basically comprises a display device, a detecting device and a control device, wherein the detecting device is used for detecting a viewing position of a viewer, and the control device may control a video frame to be converted onto a virtual plane perpendicular to visual line of the viewing position according to the viewing position detected by the detecting device and map converted video frame onto the display device. For clarity, only the difference between them will be described in detail.

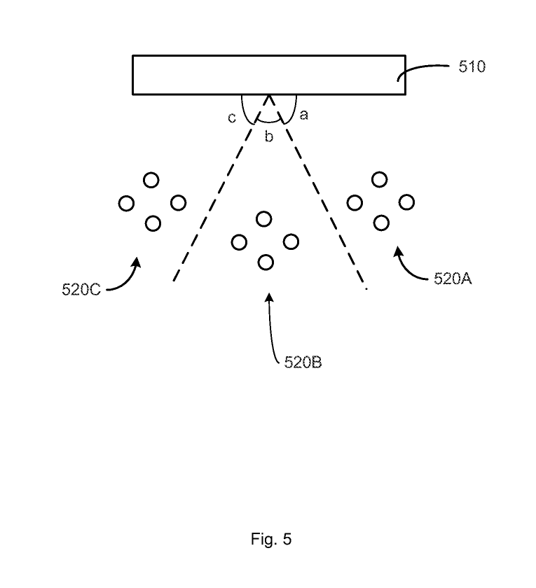

The control device groups a plurality of viewers according to the viewing position of each viewer, and calculates the average viewing position of each group of the viewers. It can be understood that the viewers close to each other should be divided into one group as much as possible, so as to decrease the deflection of the 3D image seen by each viewer. For example, as shown in FIG. 5, the area in front of the display device 510 may be divided into areas 520A, 520B and 520C. The angle corresponded by each area is 60 degree, i.e. Angle a, Angle b and Angle c are all 60 degree. Of course, other dividing manners may be adopted, as long as the viewers close to each other are in the same area. The average viewing position of each group of the viewers may be obtained according to the average value of the angles between the visual lines of the viewers in the group and the display plane of the display device, or obtained according to the centre of the viewing positions of all viewers in the group, or obtained according to the average value of the coordinates of the viewing positions of all viewers in the group, etc. Preferably, the control device divides the plurality of viewers into 2-3 groups according to each viewing position, in order to avoid flashing when the viewers view 3D video image.

Preferably, the control device controls the video frame to be converted onto the average virtual planes perpendicular to the visual lines of the average viewing positions according to the average viewing position of each group of the viewers, i.e., the video frame of each group of viewers is converted onto the corresponding average virtual plane. Then, the converted video frames are mapped onto the display device in sequence to display the corresponding 3D image on the display device in sequence. That is to say, the viewers in one group can view the same 3D image. In the first cycle for displaying 3D image, the first frames of left eye images of the first group, the first frames of left eye images of the second group and the first frames of left eye images of the third group (if divided into three groups), etc. are firstly mapped onto the display device in turn, and then the first frames of right eye images of the first group, the first frames of right eye images of the second group and the first frames of right eye images of the third group (if divided into three groups), etc. are mapped onto the display device in turn. In this way, the display of the first frames of 3D image is achieved. In the second cycle for displaying 3D image, similarly, the second frames of left eye images of the first group, the second frames of left eye images of the second group and the second frames of left eye images of the third group (if divided into three groups), etc. are firstly mapped in turn, and then the second frames of right eye images of the first group, the second frames of right eye images of the second group and the second frames of right eye images of the third group (if divided into three groups), etc. are mapped in turn. In this way, the display of the second frames of 3D image is achieved. Repeat the above steps to display the third frames of 3D image, the fourth frames of 3D image, etc., until the display of all images are achieved. Of course, during the display of each video frame, the right eye image may be displayed before the left eye image.

Further preferably, the control device controls the corresponding group of 3D glasses to simultaneously operate when the display device displays the corresponding 3D image according to the identity codes of 3D glasses worn by each group of viewers. The simultaneous operation refers to that the left or right eyes of the 3D glasses of the viewers in each group open only when the corresponding left or right eye image displays, and close at other time. As an example, the operation of the 3D glasses may be controlled by the synchronizing signal transmitted by the control device. Each pulse of the synchronizing signal may include a code bit and a status bit, wherein the code bit is used for searching for all 3D glasses in one group of 3D glasses with the matching identity code and the status bit is used for controlling the status of left or right eye of all 3D glasses in the group.

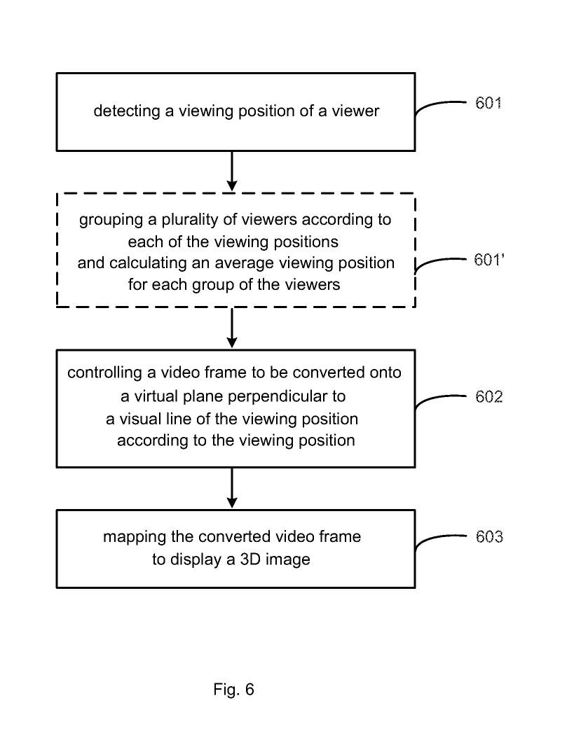

A 3D displaying method is provided in the present invention. A viewer can see the image displayed on the display device having no deflection anywhere by means of the 3D displaying method, without being limited by the viewing position. FIG. 6 is a flow chart of the 3D displaying method. The 3D displaying method will be described in detail by combining with FIG. 6 below.

Step 601, detecting a viewing position of a viewer.

The viewing position of the viewer with respect to the display device is detected. Preferably, the detecting step comprises a step of providing 3D glasses for the viewer, to determine the viewing position by detecting the position of the 3D glasses. Of course, the viewing position may be determined by detecting the seat of the viewer. In non-naked eye 3D technology, the determination of the viewing position by detecting 3D glasses can keep the viewing position being consistent with the position of the glasses of the viewer, so as to indicate the viewing position of the viewer conveniently and accurately. Preferably, the providing 3D glasses for the viewer comprises providing a plurality pairs of 3D glasses, such that a plurality of viewers can see the 3D images having no deflection. In this case, each of the plurality pairs of 3D glasses has an identity code.

Step 602, controlling a video frame to be converted onto a virtual plane perpendicular to a visual line of the viewing position according to the viewing position.

Step 603, mapping the converted video frame to display a 3D image.

Each video frame includes a frame of left eye image and a frame of right eye image which are displayed alternately, wherein the binocular stadia may be set as the international average value, i.e., 6.35 cm (which can be fine tuned on demand). The left eye image and the right eye image are alternately mapped to display 3D image having depth of field and stereo effect. The steps mentioned above, such as converting and mapping, have been known by those skilled in the art, and thus, they will be not described in detail. Of course, during the display of each video frame, the right eye image may be displayed before the left eye image.

According to one embodiment of the present invention, in the case of including a plurality of viewers, the video frame is controlled to be converted onto the corresponding virtual plane according to the viewing position of each of the viewers, and the converted video frames are mapped in sequence to display the corresponding 3D image in sequence. For example, in the first cycle for displaying 3D image, the first frames of left eye image are firstly mapped for each viewer in turn, and then the first frames of right eye image are mapped for each viewer in turn, such that the display of the first frames of 3D image is achieved. In the second cycle for displaying 3D image, similarly, the second frames of left eye image are firstly mapped for each viewer in turn, and then the second frames of right eye image are mapped for each viewer in turn, such that the display of the second frames of 3D image is achieved. Repeat the above steps to display the third frames of 3D image, the fourth frames of 3D image, etc., until the display of all images are achieved.

Preferably, based on displaying the video frame according to the above regulation, the corresponding 3D glasses are controlled to operate when the corresponding 3D image is displayed according to each of the identity codes, such that each viewer can view the 3D image. The operation refers to that the left or right eye of the 3D glasses opens only when the corresponding left or right eye image is displaying, and closes at other time. The detailed description may refer to the corresponding portion in the above, and it will be not described herein.

According to one embodiment of the present invention, in the case of including a plurality of viewers, the method of the present invention also includes: performing step 601′, i.e., grouping the plurality of viewers according to each of the viewing positions, and calculating an average viewing position for each group of the viewers. Preferably, the plurality of viewers are divided into 2-3 groups according to each of the viewing positions to avoid flashing during the viewing of the 3D video image, because of the limitation of the display device.

Preferably, the controlling step comprises controlling the video frame to be converted onto an average virtual plane perpendicular to a visual line of the average viewing position according to the average viewing position of each group of the viewers, respectively, and the mapping step comprises mapping the converted video frames in sequence to display the corresponding 3D image in sequence. In the first cycle for displaying 3D image, the first frames of left eye image are firstly mapped in turn, and then the first frames of right eye image are mapped in turn, such that the display of the first frames of 3D image is achieved, the second cycle for displaying 3D image, similarly, the second frames of left eye image are firstly mapped in turn, and then the second frames of right eye image are mapped in turn, such that the display of the second frames of 3D image is achieved. Repeat the above steps to display the third frames of 3D image, the fourth frames of 3D image, etc., until the display of all images are achieved.

Preferably, the corresponding group of 3D glasses is controlled to simultaneously operate when the corresponding 3D image is displayed according to each group of the identity codes. The simultaneous operation refers to that the left or right eyes of the 3D glasses of the viewers in each group open only when the corresponding left or right eye image displays, and close at other time. The detailed description may refer to the corresponding portion in the above, and it will be not described herein.

The present invention has been described by the above-mentioned embodiments. However, it will be understand that the above-mentioned embodiments are for the purpose of demonstration and description and not for the purpose of limiting the present to the scope of the described embodiments. Moreover, those skilled in the art could appreciated that the present invention is not limited to the above mentioned embodiments and that various modifications and adaptations in accordance of the teaching of the present invention may be made within the scope and spirit of the present invention. The protection scope of the present invention is further defined by the following claims and equivalent scope thereof.

What is claimed is:

1. A 3D display system, characterized by comprising:
a display device;
a detecting device, for detecting a viewing position of a viewer; and
a control device, for controlling a video frame to be converted onto a virtual plane perpendicular to a visual line of the viewing position according to the viewing position, and mapping the converted video frame onto the display device to display a 3D image on the display device.

2. The 3D display system according to claim 1, characterized in that the 3D display system further comprises 3D glasses, and the detecting device comprises a detecting signal transmitter disposed on the 3D glasses and a detecting signal receiver disposed on the display device, the detecting signal receiver receiving a detecting signal transmitted by the detecting signal transmitter to determine the viewing position.

3. The 3D display system according to claim 2, characterized in that the 3D glasses comprise a plurality pairs of 3D glasses worn by a plurality of viewers respectively, and each of the plurality pairs of 3D glasses has an identity code.

4. The 3D display system according to claim 3, characterized in that the control device controls the video frame to be converted onto the corresponding virtual plane according to the viewing position of each viewer, and maps the converted video frames onto the display device in sequence to display the corresponding 3D image on the display device in sequence.

5. The 3D display system according to claim 4, characterized in that the control device controls the corresponding 3D glasses according to each identity code, so as to operate when the display device displays the corresponding 3D image.

6. The 3D display system according to claim 3, characterized in that the control device groups the plurality of viewers according to each viewing position and calculates an average viewing position for each group of the viewers.

7. The 3D display system according to claim 6, characterized in that the control device controls the video frame to be converted onto an average virtual plane perpendicular to a visual line of the average viewing position according to the average viewing position of each group of the viewers, respectively, and maps the converted video frames onto the display device in sequence to display the corresponding 3D image on the display device in sequence.

8. The 3D display system according to claim 7, characterized in that the control device controls the corresponding group of the 3D glasses according to each group of the identity codes, so as to simultaneously operate when the display device displays the corresponding 3D image.

9. The 3D display system according to claim 6, characterized in that the control device divides the plurality of viewers into 2-3 groups according to each viewing position.

10. A 3D displaying method, characterized by comprising the following steps:
detecting a viewing position of a viewer;
controlling a video frame to be converted onto a virtual plane perpendicular to a visual line of the viewing position according to the viewing position; and
mapping the converted video frame to display a 3D image.

11. The 3D displaying method according to claim 10, characterized in that the detecting step comprises a step of providing 3D glasses for the viewer, to determine the viewing position by detecting the position of the 3D glasses.

12. The 3D displaying method according to claim 11, characterized in that the providing step comprises providing a plurality pairs of 3D glasses for a plurality of viewers, and each of the plurality pairs of 3D glasses has an identity code.

13. The 3D displaying method according to claim 12, characterized in that the controlling step comprises controlling the video frame to be converted onto the corresponding virtual plane according to the viewing position of each viewer, and the mapping step comprises mapping the converted video frames in sequence to display the corresponding 3D image in sequence.

14. The 3D displaying method according to claim 13, characterized in that the 3D displaying method further comprises controlling the corresponding 3D glasses according to each identity code, so as to operate when the corresponding 3D image is displayed.

15. The 3D displaying method according to claim 12, characterized in that the 3D displaying method further comprises grouping the plurality of viewers according to each viewing position, and calculating an average viewing position for each group of the viewers.

16. The 3D displaying method according to claim 15, characterized in that the controlling step comprises controlling the video frame to be converted onto an average virtual plane perpendicular to a visual line of the average viewing position according to the average viewing position of each group of the viewers, respectively, and the mapping step comprises mapping the converted video frames in sequence to display the corresponding 3D image in sequence.

17. The 3D displaying method according to claim 16, characterized in that the 3D displaying method further comprises controlling the corresponding group of the 3D glasses according to each group of the identity codes, so as to simultaneously operate when the corresponding 3D image is displayed.

18. The 3D displaying method according to claim 15, characterized in that the grouping the plurality of viewers comprises dividing the plurality of viewers into 2-3 groups according to each viewing position.
